(19) United States
(12) Patent Application Publication
(10) Pub. No.: US 2007/0229718 A1
(43) Pub. Date: Oct. 4, 2007

(54) System for Using Larger Arc Lamps with Smaller Imagers

(76) Inventor: Estill Thone Hall JR., Indianapolis, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/579,849

(22) PCT Filed: May 11, 2004
(86) PCT No.: PCT/US04/14657

§ 371 Date: Nov. 8, 2006

(51) Int. Cl. H04N 9/31

(52) U.S. Cl. 348/744

(57) ABSTRACT

A projection system is provided with improved contrast and reduced artifacts using a larger lamp to maintain good lamp life. The projection system uses two imagers, the first being larger to accommodate a large lamp, sized to the first imager and the second being smaller. The first imager has a matrix of pixels for modulating light on a pixel-by-pixel basis to form a first modulated matrix of light. The second imager has a matrix of pixels corresponding to the pixels of the first imager for modulating the first modulated matrix of light on a pixel-by-pixel basis to form a second modulated matrix of light. The second imager having a size smaller than the size of the first imager. A relay lens set provides a magnification of less than 1.0 to relay each pixel of light in the first modulated matrix of light onto a corresponding pixel of the second imager.

### FIELD OF THE INVENTION

The invention relates to a multiple imager projection system using a large arc lamp with a projection system having a smaller imager.

### BACKGROUND OF THE INVENTION

Microdisplays using Digital Light Processing (DLP) and/or Liquid crystal display (LCD), and particularly liquid crystal on silicon (LCOS), imagers are becoming increasingly prevalent in imaging devices such as rear projection television (RPTV).

Digital Light Processing (DLP) imagers use an array of micro-mirrors, each acting as a pixel, which are pivoted at a very high rate of speed to temporally modulate light intensity on a pixel-by-pixel basis.

Liquid crystal displays (LCD's), and particularly liquid crystal on silicon (LCOS) systems use a reflective light engine or imager. In an LCOS system, projected light is polarized by a polarizing beam splitter (PBS) and directed onto a LCOS imager or light engine comprising a matrix or array of pixels. Throughout this specification, and consistent with the practice of the relevant art, the term pixel is used to designate a small area or dot of an image, the corresponding portion of a light transmission, and the portion of an imager producing that light transmission.

Each pixel of the DLP or LCOS imager modulates the light incident on it according to a gray-scale factor input to the imager or light engine to form a matrix of discrete modulated light signals or pixels. The matrix of modulated light signals is reflected or output from the imager and directed to a system of projection lenses which project the modulated light onto a display screen, combining the pixels of light to form a viewable image. In this system, the gray-scale variation from pixel to pixel is limited by the number of bits used to process the image signal. The contrast ratio from bright state (i.e., maximum light) to dark state (minimum light) is limited by the leakage of light in the imager.

One of the major disadvantages of existing LCOS and DLP systems is the difficulty in reducing the amount of light in the dark state, and the resulting difficulty in providing outstanding contrast ratios. This is, in part, due to the leakage of light, inherent in these systems.

In addition, since the input is a fixed number of bits (e.g., 8, 10, etc.), which must define the full scale of light, there tend to be very few bits available to define subtle differences in darker areas of the picture. This can lead to contouring artifacts.

One approach to enhance contrast in LCOS in the dark state is to use a COLORSWITCH™ or similar device to scale the entire picture based upon the maximum value in that particular frame. This improves some pictures, but does little for pictures that contain high and low light levels. Other attempts to solve the problem have been directed to making better imagers, etc. but these are at best incremental improvements.

In microdisplay systems, a general, very desirable tendency is the reduction of the imager area. This is desirable because of improved yields on the imager, and smaller optical components, thus reducing the cost of the system. Reducing the imager area places increasing constraints on the arc lamp design. As the imager shrinks the arc lamp must also be scaled down in size to keep the etandue constant. The reduction in size of the arc lamp results in increasingly shorter arc lamp life, causing increased maintenance and cost to operate the microdisplay.

### SUMMARY OF THE INVENTION

The invention provides a projection system that provides improved contrast and contouring of a light signal on a pixel-by-pixel basis using a two-stage projection architecture, thus improving all video pictures. The projection system uses two imagers, the first being larger to accommodate a large lamp, sized to the first imager and the second being smaller. The first imager has a matrix of pixels for modulating light on a pixel-by-pixel basis to form a first modulated matrix of light. The second imager has a matrix of pixels corresponding to the pixels of the first imager for modulating the first modulated matrix of light on a pixel-by-pixel basis to form a second modulated matrix of light. The second imager having a size smaller than the size of the first imager. A relay lens set provides a magnification of less than 1.0 to relay each pixel of light in the first modulated matrix of light onto a corresponding pixel of the second imager.

### BRIEF DESCRIPTION OF THE DRAWINGS

The invention will now be described with reference to accompanying figures of which:

FIG. 1 shows a block diagram of an LCOS projection system with a two-stage projection architecture according to an exemplary embodiment of the present invention;

FIG. 2 shows an exemplary lens relay system for the projection system of FIG. 1; and

FIG. 3 shows calculated ensquared energy performance for the lens system of FIG. 2.

### DETAILED DESCRIPTION OF THE INVENTION

The present invention provides a projection system, such as for a television display, with enhanced contrast ratio and reduced contouring, while providing good lamp life. This is accomplished by using a larger imager 50 for the first stage to maintain a larger lamp 10, and a smaller image 60 for the second stage. In the embodiment illustrated, lamp 10 may be an arc lamp generating white light 1, suitable for use in an LCOS system. For example a short-arc mercury lamp may be used. The white light 1 enters an integrator 20, which directs a telecentric beam of white light 1 toward the projection system 30. The white light 1 is then separated into its component red, green, and blue (RGB) bands of light 2. The RGB light 2 may be separated by dichroic mirrors (not shown) and directed into separate red, green, and blue projection systems 30 for modulation. The modulated RGB light 2 is then recombined by a prism assembly (not shown) and projected by a projection lens assembly 40 onto a display screen (not shown).

Alternatively, the white light 1 may be separated into RGB bands of light 2 in the time domain, for example, by a color wheel (not shown), and thus directed one-at-a-time into a single LCOS projection system 30.

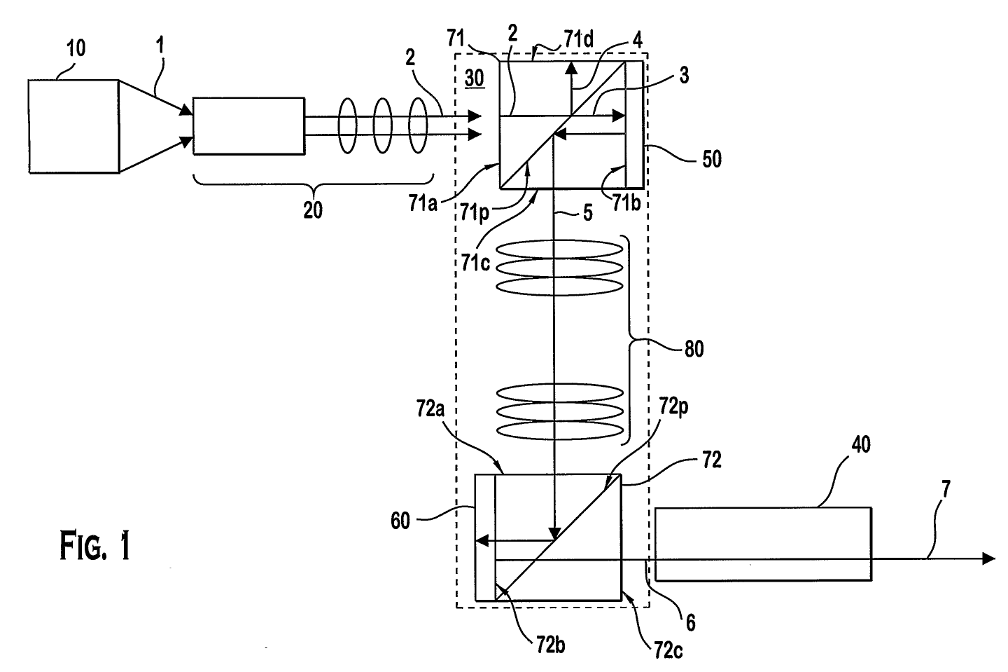

An exemplary LCOS projection system 30 is illustrated in FIG. 1, using a two-stage projection architecture having a larger imager 50 and a smaller imager 60 according to the present invention. The monochromatic RGB bands of light 2 are sequentially modulated by the two different sized imagers 50, 60 on a pixel-by-pixel basis. The RGB bands of light 2 comprise randomly polarized light. These RGB bands of light 2 enter a first surface 71a of a first PBS 71 and are polarized by a polarizing surface 71p within the first PBS 71. The polarizing surface 71p allows a p-polarized component 3 of the RGB bands of light 2 to pass through the first PBS 71 to a second surface 71b, while reflecting an s-polarized component 4 at an angle, away from the projection path where it passes out of first PBS 71 through fourth surface 71d. A first imager 50 is disposed beyond the second surface 71b of the first PBS 71 opposite the first face 71a, where the RGB bands of light enter first PBS 71. The p-polarized component 3, which passes through the PBS 71, is therefore incident on the first imager 50.

In the exemplary embodiment, illustrated in FIG. 1, first imager 50 is a LCOS imager (as will be described in greater detail below) comprising a matrix of polarized liquid crystals corresponding to the pixels of the display image (not shown). These crystals transmit light according to their orientation, which in turn varies with the strength of an electric field created by a signal provided to the first imager 50. The imager pixels modulate the p-polarized light 3 on a pixel-by-pixel basis proportional to a gray scale value provided to the first imager 50 for each individual pixel. As a result of the modulation of individual pixels, the first imager 50 provides a first light matrix 5, comprising a matrix of pixels or discrete dots of light. First light matrix 5 is an output of modulated s-polarized light reflected from the first imager 50 back through second surface 71b of first PBS 71, where it is reflected by a polarizing surface 71p at an angle out of the first PBS 71 through a third surface 71c. Each pixel of the first light matrix 5 has an intensity or luminance proportional to the individual gray scale value provided for that pixel in first imager 50.

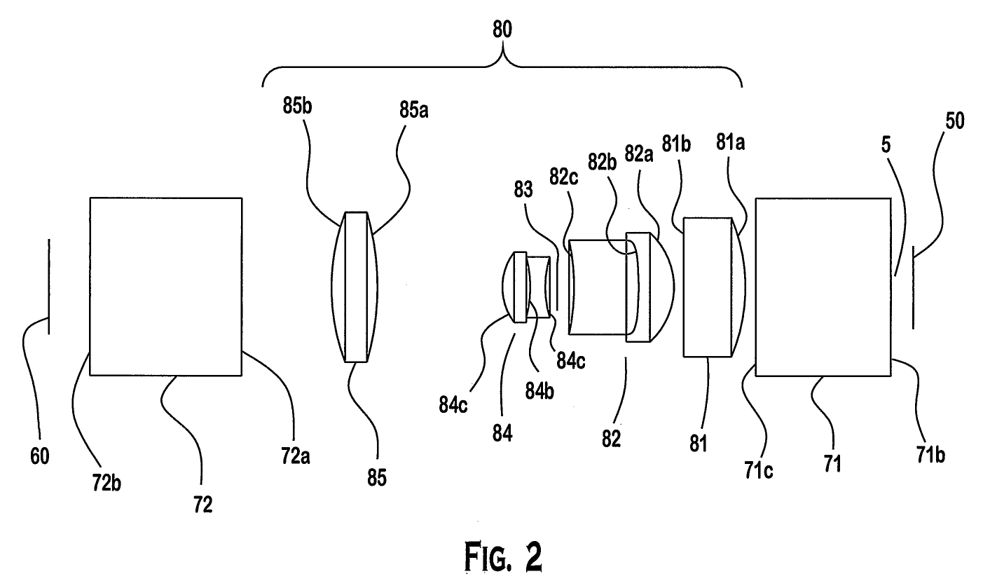

The first light matrix 5 of s-polarized light is reflected by the PBS 71 through a relay lens system 80, which provides a magnification of less than one to project each pixel of first light matrix 5 onto a corresponding pixel of smaller imager 60. In an exemplary embodiment, illustrated in FIG. 2, relay lens system 80 comprises a series of aspherical lenses, some of which are formed into acromats. The lenses are configured to provide low distortion of the image being transmitted with a magnification of less than 1, so that the output of each pixel in the first imager 50 is projected onto a corresponding pixel of the second imager 60.

As shown in FIG. 2, exemplary relay lens system 80 comprises a first aspheric lens 81 and a first acromatic lens 82 (comprising two aspheres) between the first PBS 71 and the focal point of the lens system or system stop 83. Between the system stop 83 and the second imager 72, lens system 80 comprises a second acromatic lens 84 (comprising two aspheres) and a second aspheric lens 85. First aspheric lens 81 has a first surface 81a and second surface 81b which bend the diverging light pattern from the first PBS 71 into a light pattern converging toward the optical axis of lens system 80. First acromatic lens 82 has a first surface 82a, a second surface 82b, and a third surface 82c, which focus the converging light pattern from the first aspheric lens 81 onto the system stop 83. At the system stop 83, the light pattern inverts and diverges. The second acromatic lens 84 has a first surface 84a, a second surface 84b, and a third surface 84c. The surfaces 84a, 84b, and 84c of second acromatic lens 84 distribute the diverging light pattern onto the second aspherical lens 85. The second aspherical lens 85, has a first surface 85a and a second surface 85b. Surfaces 85a and 85b bend the light pattern to converge to form an inverted image on the second imager 60 that has pixels with a one-to-one correspondence to the matrix of pixels from the first imager 50. The surfaces of relay lens system 80 are configured to work with the imagers 50, 60 and PBS's 71, 72 to achieve the one-to-one correspondence of the pixels of first imager 50 and second imager 60. An exemplary lens set 80 was developed by the inventors using ZEMAX™ software and design criteria developed by the inventors. A summary of the surfaces of an exemplary two-stage projection system 30 are provided in Table 1, and aspheric coefficients for the surfaces are provided in Table 2. The exemplary lens system described in Tables 1 and 2 provides one-to-one transmission from the pixels of a 0.7 inch larger imager 50 to a 0.5 inch smaller imager 60. Various modifications can be made to this exemplary projection system based on such factors as: cost, size, luminance levels, and other design factors.

TABLE 1
(dimensions in millimeters)

| Surface | Type | Radius | Thickness | Glass | Diameter | Conic |
|---|---|---|---|---|---|---|
| 50 | Standard | Infinity | 7.344807 | | 17.844 | 0 |
| 71b | Standard | Infinity | 28 | SF2 | 19.49308 | 0 |
| 71c | Standard | Infinity | 16.144 | | 23.30644 | 0 |
| 81a | Evenasph | −1792.427 | 8.465153 | BAK2 | 27.53717 | 15896.17 |
| 81b | Evenasph | −47.64756 | 22.60534 | | 25.79954 | 0.1385228 |
| 82a | Evenasph | 9.989885 | 5.216671 | BAF3 | 12.28836 | 0.2461029 |
| 82b | Evenasph | −15.70192 | 2.781307 | SF64A | 10.44962 | 0.3273907 |
| 82c | Evenasph | 10.4408 | 2.35585 | | 7.466488 | 1.112838 |
| 83 | Standard | Infinity | 2.701553 | | 7.598633 | 0 |
| 84a | Evenasph | −12.47 | 12.27089 | LLF1 | 9.027755 | −0.9337399 |
| 84b | Evenasph | 21.61151 | 6.568487 | BK10 | 16.55144 | −60.03617 |
| 84c | Evenasph | −10.36284 | 1.205388 | | 19.1303 | −0.09623429 |
| 85a | Evenasph | 25.32294 | 11.75584 | BAK2 | 19.59857 | −10.12812 |
| 85b | Evenasph | −156.8982 | 2.033251 | | 24.39482 | 91.45723 |
| 72a | Standard | Infinity | 25 | SF2 | 26.27618 | 0 |
| 72b | Standard | Infinity | 3.796829 | | 32.14654 | 0 |
| 60 | Standard | Infinity | | | 12.7 | 0 |

TABLE 2

| coefficient | | | | |
|---|---|---|---|---|
| on: | surfaces 81a | surfaces 81b | surfaces 82a | Surfaces 82b |
| r² | 0.010014379 | −0.0042525592 | −0.00049308956 | −0.0024450588 |
| r⁴ | 8.2837304e−006 | 5.9994341e−006 | −4.2471681e−006 | 6.544755e−005 |
| r⁶ | −1.5974119e−008 | 4.1263492e−008 | 6.7784397e−007 | −7.0268435e−006 |
| r⁸ | 7.1436629e−010 | −2.2599135e−010 | 8.2484037e−009 | 2.5319053e−007 |
| r¹⁰ | −4.055464e−012 | 4.7166887e−012 | 3.8235422e−010 | 1.2042165e−008 |
| r¹² | 5.5374003e−015 | −9.3608006e−015 | −8.7314699e−012 | 1.4415007e−010 |
| r¹⁴ | 2.4154668e−017 | −2.7355431e−016 | −5.5310433e−013 | −2.9191172e−011 |
| r¹⁶ | 1.7819688e−019 | 1.6718734e−018 | 1.6816709e−014 | 3.2892181e−013 |
| coefficient | | | | |
| on: | Surfaces 82c | Surfaces 84a | Surfaces 84b | surfaces 85a |
| r² | 0.0016585768 | −0.0042693384 | −0.028244602 | −0.0014200358 |
| r⁴ | 0.00016676655 | 5.0145851e−005 | −0.0002613112 | −6.6572718e−005 |
| r⁶ | 8.858413e−006 | 6.8120651e−006 | 2.4697573e−007 | −2.0323262e−007 |
| r⁸ | −6.6560983e−008 | 2.0863961e−008 | 2.5116094e−008 | −5.5412448e−009 |
| r¹⁰ | 1.0434302e−008 | 9.6869445e−009 | 9.9630717e−010 | 2.5013767e−011 |
| r¹² | 2.9470636e−009 | 8.0172475e−010 | 9.3849316e−012 | 6.8917014e−013 |
| r¹⁴ | 1.4144848e−010 | 1.1496028e−011 | −8.4444523e−014 | 3.5809263e−015 |
| r¹⁶ | −1.3523988e−011 | −2.6695627e−012 | −4.9434548e−015 | −1.2508138e−016 |

| coefficient | | |
|---|---|---|
| on: | surfaces 85b | surfaces 84c |
| r² | 0.010232017 | 0.0018730125 |
| r⁴ | −0.00022008009 | 4.8192806e−005 |
| r⁶ | 1.5992026e−007 | 6.3746875e−007 |
| r⁸ | 4.409598e−009 | 5.2485121e−010 |
| r¹⁰ | −7.4775294e−012 | 8.1903143e−012 |
| r¹² | −1.339599e−013 | 1.1898319e−013 |
| r¹⁴ | −2.2536409e−015 | 4.9712202e−016 |
| r¹⁶ | 1.722549e−017 | 3.8319894e−017 |

After the first light matrix 5 leaves the relay lens system 80, it enters into a second PBS 72 through a first surface 72a. Second PBS 72 has a polarizing surface 72p that reflects the s-polarized first light matrix 5 through a second surface 72b onto a second imager 60. In the exemplary embodiment, illustrated in FIG. 1, second imager 60 is an LCOS imager which modulates the previously modulated first light matrix 5 on a pixel-by-pixel basis proportional to a gray scale value provided to the second imager 60 for each individual pixel. The pixels of the second imager 60 corresponds on a one-to-one basis with the pixels of the first imager 50 and with the pixels of the display image. Thus, the input of a particular pixel (i,j) to the second imager 60 is the output from corresponding pixel (i,j) of the first imager 50.

The second imager 60 then produces an output matrix 6 of p-polarized light. Each pixel of light in the output matrix 6 is modulated in intensity by a gray scale value provided to the imager for that pixel of the second imager 60. Thus a specific pixel of the output matrix 6 (i,j) would have an intensity proportional to both the gray scale value for its corresponding pixel (i,j), in the first imager and its corresponding pixel (i,j)₂ in the second imager 60.

The lamp 10 must be sized to the first stage imager to maintain the desired etandue. Using a larger imager 50 in the first stage of the projection system 30 allows the lamp 10 to be larger, resulting in longer lamp life. Moreover a more modest imager (in terms of contrast ratio) can be used for the larger imager 50, because a second, smaller imager 60 will also be used to modulate the projected image. The modest large imager 50 receives the lamp 10 illumination (from a larger arc lamp) and then relays the light using a now less than unity magnification lens to illuminate on a pixel by pixel basis a “high quality” smaller imager 60. In the illustrated exemplary embodiment a ˜0.7″ larger imager 50 is used as an illumination imager, and a ˜0.5″ smaller imager 60 is used as an image making imager. The relay lens system 80, as described above provides one-to-one correspondence between the pixels of the larger imager 50 and the smaller imager 60.

The light output L of a particular pixel (i,j) is given by the product of the light incident on the given pixel of first imager 50, the gray scale value selected for the given pixel at first imager 50, and the gray scale value selected at second imager 60:
L=L0×G1×G2

L0 is a constant for a given pixel (being a function of the lamp 10, and the illumination system.) Thus, the light output L is actually determined primarily by the gray scale values selected for this pixel on each imager 50, 60. For example, normalizing the gray scales to 1 maximum and assuming each imager has a very modest contrast ratio of 200:1, then the bright state of a pixel (i,j) is 1, and the dark state of pixel (i,j) is 1/200 (not zero, because of leakage). Thus, the two stage projector architecture has a luminance range of 40,000:1.
L max=1×1=1;
L min=0.005×0.005=0.000025

The luminance range defined by these limits gives a contrast ratio of 1/0.000025:1, or 40,000:1. Importantly, the dark state luminance for the exemplary two-stage projector architecture would be only a forty-thousandth of the luminance of the bright state, rather than one two-hundredth of the bright state if the hypothetical imager were used in an existing single imager architecture. As will be understood by those skilled in the art, an imager with a lower contrast ratio can be provided for a considerably lower cost than an imager with a higher contrast ratio. Thus, a two-stage projection system using two imagers with a contrast ratio of 200:1 will provide a contrast ratio of 40,000:1, while a single-stage projection system using a much more expensive imager with a 500:1 ratio will only provide a 500:1 contrast. Also, a two-stage projection system with one imager having a 500:1 contrast ratio and an inexpensive imager with a 200:1 ratio will have a system contrast ratio of 100,000:1. Accordingly, a cost/performance trade-off can be performed to create an optimum projection system.

Output matrix 6 enters the second PBS 72 through second surface 72b, and since it comprises p-polarized light, it passes through polarizing surface 72p and out of the second PBS 72 through third surface 72c. After output matrix 6 leaves the second PBS 72, it enters the projection lens assembly 40, which projects a display image 7 onto a screen (not shown) for viewing.

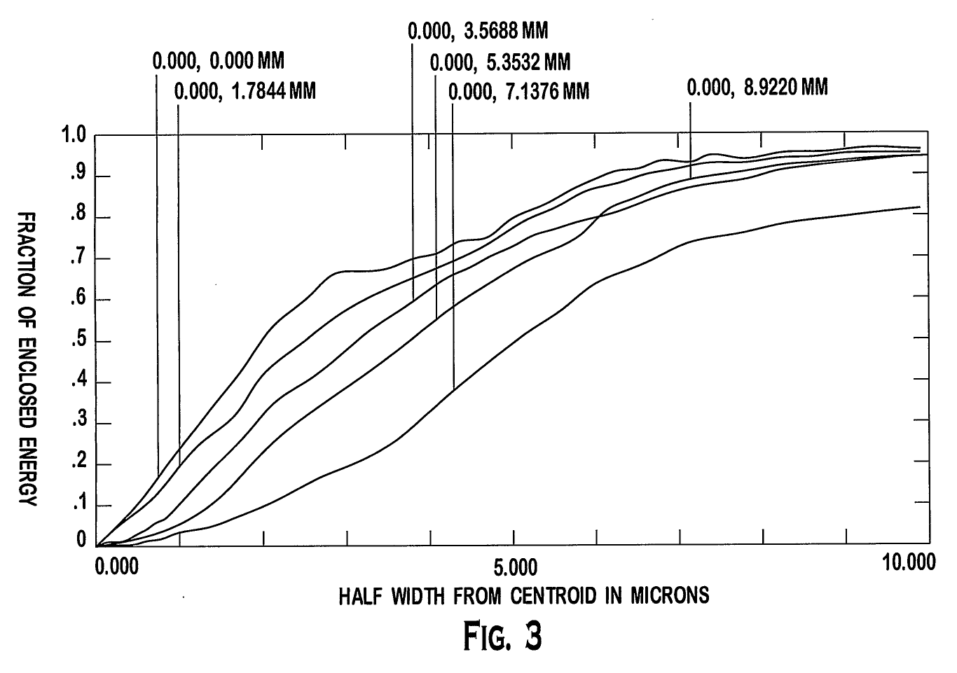

To provide one-to-one correspondence between the pixels of the first imager 50 and the second imager 60, the relay lens set 80 must provide good ensquared light energy. That is, the light from a pixel (i,j) in the first imager 50 must be accurately projected onto the corresponding pixel (i,j) on the second imager 60. FIG. 3 shows a calculated result for ensquared energy of the illustrated lens set 80. The ensquared energy was calculated for the exemplary lens set 80 using ZEMAX™ software. As shown in FIG. 3, at least about fifty percent (60%) of the light energy from a particular pixel on a first stage imager 50 is focused onto a twelve micron square (e.g., the corresponding pixel of a second stage imager 60).

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A projection system, comprising:
a first imager having a matrix of pixels for modulating light on a pixel-by-pixel basis to form a first modulated matrix of light, the first imager having a first size;
a second imager having a matrix of pixels corresponding to the pixels of the first imager for modulating the first modulated matrix of light on a pixel-by-pixel basis to form a second modulated matrix of light, the second imager having a second size smaller than the first size;
a relay lens set having a magnification of less than 1.0 to relay each pixel of light in the first modulated matrix of light onto a corresponding pixel of the second imager; and
a lamp sized for the first imager.

2. The projection system of claim 1, wherein the first imager has a size of about 0.7 inches and the second imager has a size of about 0.5 inches.

3. The projection system of claim 1, wherein the relay lens set comprises six lens elements.

4. The projection system of claim 3, wherein the first and sixth lens elements are aspheres.

5. The projection system of claim 4, wherein the second and third elements are aspheric lens elements joined at the exit face of the second element and entrance face of the third element to form an acromat.

6. The projection system of claim 5 wherein the fourth and fifth elements are aspheric lens elements joined at the exit face of the fourth element and entrance face of the fifth element to form an acromat.

7. The projection system of claim 1, wherein at least 60% of the light energy from the first imager is focused onto a twelve micron square on the second imager.

8. The projection system of claim 1, wherein the relay lens set has an ensquared energy of about 70% within a twelve micron square.
